(19) United States
(12) Patent Application Publication
(10) Pub. No.: US 2015/0234316 A1
(43) Pub. Date: Aug. 20, 2015

(54) IMAGE FORMING APPARATUS INCORPORATING CONTROLLER FOR DETERMINING EXPOSURE USED FOR IMAGE FORMATION AND IMAGE FORMING METHOD FOR DETERMINING EXPOSURE USED FOR IMAGE FORMATION

(71) Applicants: Hideaki Kanaya, Tokyo (JP); Jun Yura, Kanagawa (JP); Takeshi Uchitani, Kanagawa (JP); Shunichi Hashimoto, Kanagawa (JP); Yushi Hirayama, Kanagawa (JP); Takuya Suganuma, Kanagawa (JP); Hiroki Ishii, Kanagawa (JP); Hironobu Takeshita, Kanagawa (JP); Shogo Kezuka, Tokyo (JP)

(72) Inventors: Hideaki Kanaya, Tokyo (JP); Jun Yura, Kanagawa (JP); Takeshi Uchitani, Kanagawa (JP); Shunichi Hashimoto, Kanagawa (JP); Yushi Hirayama, Kanagawa (JP); Takuya Suganuma, Kanagawa (JP); Hiroki Ishii, Kanagawa (JP); Hironobu Takeshita, Kanagawa (JP); Shogo Kezuka, Tokyo (JP)

(21) Appl. No.: 14/612,466

(22) Filed: Feb. 3, 2015

(30) Foreign Application Priority Data
Feb. 14, 2014 (JP) 2014-027045
Nov. 26, 2014 (JP) 2014-238841

(51) Int. Cl. G03G 15/08

(52) U.S. Cl. CPC G03G 15/0848; G03G 2215/0602

(57) ABSTRACT

An image forming apparatus includes an image bearer, a charger, an exposure device, a developing device, an image density sensor, and a controller. The controller is configured to charge the image bearer, expose the image bearer with a first exposure that saturates potential of the image bearer after exposure to form a latent image pattern on the image bearer, develop the latent image pattern into a toner pattern while changing a developing electrical field, detect a first image density of the toner pattern, determine developing bias and charging bias, form patterns with the first exposure and a second exposure smaller than the first exposure, detect a second image density of the patterns, and determine an exposure to output an image based on the second image density, the first exposure, and the second exposure.

### CROSS-REFERENCE TO RELATED APPLICATIONS

This patent application is based on and claims priority pursuant to 35 U.S.C. §119(a) to Japanese Patent Application Nos. 2014-027045, filed on Feb. 14, 2014, and 2014-238841, filed on Nov. 26, 2014, in the Japan Patent Office, the entire disclosure of each of which is hereby incorporated by reference herein.

### BACKGROUND

1. Technical Field

Embodiments of the present invention generally relate to an image forming apparatus and an image forming method for forming an image on a recording medium with the image forming apparatus.

2. Background Art

Various types of electrophotographic image forming apparatuses are known, including copiers, printers, facsimile machines, and multifunction machines having two or more of copying, printing, scanning, facsimile, plotter, and other capabilities. Such image forming apparatuses usually form an image on a recording medium according to image data. Specifically, in such image forming apparatuses, for example, a charger uniformly charges a surface of a photoconductor serving as an image carrier. An optical writer irradiates the surface of the photoconductor thus charged with a light beam to form an electrostatic latent image on the surface of the photoconductor according to the image data. A developing device supplies toner to the electrostatic latent image thus formed to render the electrostatic latent image visible as a toner image. The toner image is then transferred onto a recording medium directly, or indirectly via an intermediate transfer belt. Finally, a fixing device applies heat and pressure to the recording medium carrying the toner image to fix the toner image onto the recording medium.

### SUMMARY

In one embodiment of the present invention, an improved image forming apparatus is described that includes an image bearer, a charger to charge the image bearer, an exposure device to expose the image bearer charged by the charger to form an electrostatic latent image on the image bearer, a developing device to develop the electrostatic latent image with toner into a toner image, an image density sensor to detect image density of the toner image, and a controller to determine an exposure. The controller is configured to charge the image bearer with the charger, expose the image bearer with the exposure device with a first exposure that saturates potential of the image bearer after exposure to form a latent image pattern on the image bearer, develop the latent image pattern into a toner pattern with the developing device while changing a developing electrical field, detect a first image density of the toner pattern with the image density sensor, determine developing bias and charging bias based on the first image density and data of the developing electrical field, form a plurality of patterns with the first exposure and with a second exposure smaller than the first exposure based on the charging bias and the developing bias, detect a second image density of the plurality of patterns with the image density sensor, and determine an exposure to output an image based on the second image density, the first exposure, and the second exposure.

Also described is an improved image forming method that includes charging an image bearer, exposing the image bearer with a first exposure that saturates potential of the image bearer after exposure to form a latent image pattern on the image bearer, developing the latent image pattern into a toner pattern while changing a developing electrical field, detecting a first image density of the toner pattern, determining developing bias and charging bias based on the first image density and data of the developing electrical field, forming a plurality of patterns with the first exposure and with a second exposure smaller than the first exposure based on the charging bias and the developing bias, detecting a second image density of the plurality of patterns, and determining an exposure to output an image, based on the second image density, the first exposure, and the second exposure.

### BRIEF DESCRIPTION OF THE DRAWINGS

A more complete appreciation of the disclosure and many of the attendant advantages thereof will be more readily obtained as the same becomes better understood by reference to the following detailed description of embodiments when considered in connection with the accompanying drawings, wherein:

FIG. 1 is a schematic sectional view of an image forming apparatus according to an embodiment of the present invention;

FIG. 2 is a partial enlarged schematic view of the image forming apparatus, illustrating a position of a density sensor incorporated in the image forming apparatus;

FIG. 3 is a schematic sectional view of the density sensor;

FIG. 4 is a block diagram of a controller operatively connected to components of the image forming apparatus;

FIG. 5 is a flowchart of a process of determining image formation conditions according to a first embodiment of the present invention;

FIG. 6 is a graph illustrating potential of a photoconductor and developing bias upon formation of a pattern for determining developing bias;

FIG. 7 is a plan view of the pattern;

FIG. 8 is a graph illustrating a relation between density and developing potential for determining developing bias;

FIG. 9 is a graph illustrating digital gamma characteristics;

FIG. 10 is a graph illustrating a correlation between exposure and surface potential after exposure, with target potential after exposure;

FIG. 11 is a graph of a relation between density and exposure intensity for determining an exposure;

FIG. 12 is a graph of a relation between density and exposure intensity for determining an exposure with different charging potentials;

FIG. 13 is a flowchart of a process of determining an exposure according to a third embodiment of the present invention;

FIG. 14 is a graph of a relation between charging potential and exposure; and

FIG. 15 is a flowchart of a process of determining an exposure according to a fourth embodiment of the present invention.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the invention and not all of the components or elements described in the embodiments of the present invention are indispensable.

In a later-described comparative example, embodiment, and exemplary variation, for the sake of simplicity like reference numerals are given to identical or corresponding constituent elements such as parts and materials having the same functions, and redundant descriptions thereof are omitted unless otherwise required.

It is to be noted that, in the following description, suffixes Y, C, M, and K denote colors yellow, cyan, magenta, and black, respectively. To simplify the description, these suffixes are omitted unless necessary.

Referring now to the drawings, wherein like reference numerals designate identical or corresponding parts throughout the several views, embodiments of the present invention are described below.

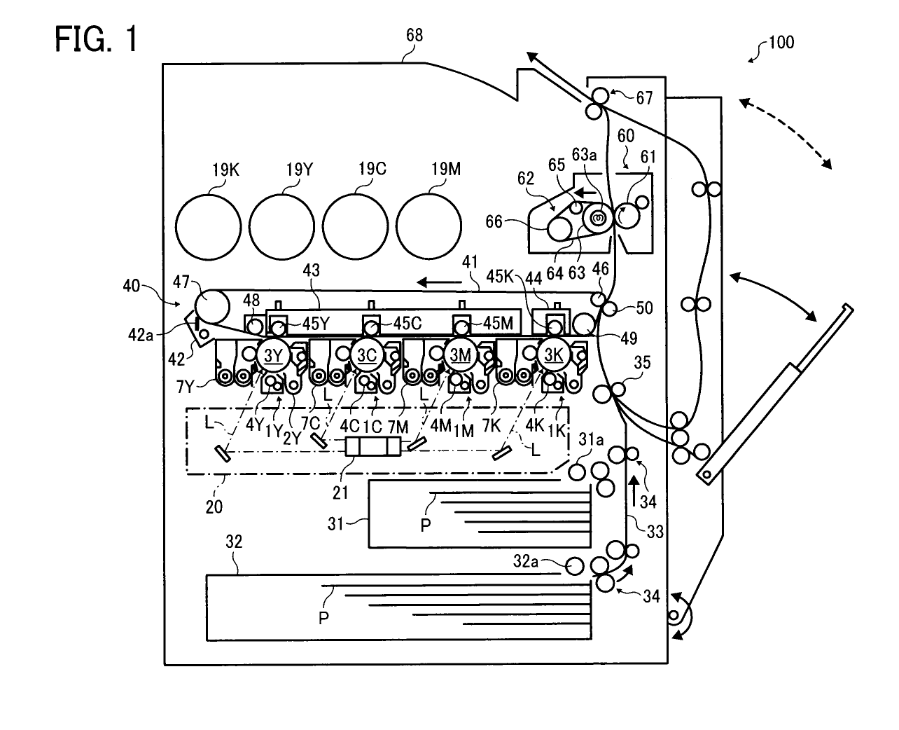

Initially with reference to FIG. 1, a description is given of an image forming apparatus 100 according to an embodiment of the present invention.

FIG. 1 is a schematic sectional view of the image forming apparatus 100. In the present embodiment, the image forming apparatus 100 is a printer, and includes four image forming units 1Y, 1C, 1M and 1K to form toner images of yellow (Y), cyan (C), magenta (M), and black (K), respectively. The image forming units 1Y, 1C, 1M, and 1K are identical in configuration, differing only in the color of toner employed.

A detailed description is now given of the image forming unit 1Y as a representative of the four image forming units 1Y, 1C, 1M, and 1K. The image forming unit 1Y includes a photoconductor unit 2Y and a developing device 7Y. The photoconductor unit 2Y includes a photoconductor 3Y serving as an image bearer, and a charger 4Y that charges the photoconductor 3Y to predetermined charging potential. The photoconductor unit 2Y and the developing device 7Y are removable from the image forming apparatus 100 as integral parts of the image forming unit 1Y. It is to be noted that, once the image forming unit 1Y is removed from the image forming apparatus 100, the developing device 7Y is removable from the photoconductor unit 2Y.

Below the image forming units 1Y, 1C, 1M, and 1K is an exposure device 20, which is an optical writing device to form a latent image. The exposure device 20 includes, e.g., light sources to emit laser beams L, a polygon mirror 21 rotated by a motor to deflect the laser beams L, and a plurality of optical lenses and mirrors through which the laser beams L pass and finally reach the photoconductors 3Y, 3C, 3M, and 3K. Alternatively, the exposure device 20 may include a light emitting diode (LED) array. Thus, the exposure device 20 irradiates the photoconductors 3Y, 3C, 3M, and 3K of the image forming units 1Y, 1C, 1M, and 1K with the laser beams L according to image data to form electrostatic latent images on the photoconductors 3Y, 3C, 3M, and 3K. The developing devices 7Y, 7C, 7M, and 7K attach toner to the electrostatic latent images thus formed, rendering the electrostatic latent images visible as toner images on the photoconductors 3Y, 3C, 3M, and 3K, respectively. The amount of toner used is determined by developing potential, which is potential difference between the developing bias of the developing devices 7 and the potential of the electrostatic latent images of the photoconductors 3.

Below the exposure device 20 are disposed a first tray 31 and a second tray 32. Each of the first and second trays 31 and 32 accommodates recording media P arranged in a stack. A first feed roller 31a contacts an uppermost one of the recording media P stacked in the first tray 31. Similarly, a second feed roller 32a contacts an uppermost one of the recording media P stacked in the second tray 32. When rotated in a counterclockwise direction in FIG. 1 by a driver, the first feed roller 31a feeds the uppermost recording medium P from the first tray 31 toward a recording medium conveyance passage 33, defined by internal components of the image forming apparatus 100, that extends vertically along the right side of the first and second trays 31 and 32 in FIG. 1. Similarly, when rotated in the counterclockwise direction in FIG. 1 by a driver, the second feed roller 32a feeds the uppermost recording medium P from the second tray 32 toward the recording medium conveyance passage 33. Pairs of conveyance rollers 34 are disposed along the recording medium conveyance passage 33 to sandwich the recording medium P thus fed to the recording medium conveyance passage 33 between their respective rollers to convey the recording medium P along the recording medium conveyance passage 33 upward in FIG. 1 toward a pair of registration rollers 35 disposed at an end of the recording medium conveyance passage 33. As soon as the pair of registration rollers 35 receives and sandwiches the recording medium P between its rollers, the pair of registration rollers 35 temporarily stops rotation of its rollers. Then, at a predetermined time, the pair of registration rollers 35 feeds the recording medium P toward a secondary transfer nip, described later.

Above the image forming units 1Y, 1C, 1M, and 1K is a transfer device 40. The transfer device 40 includes, e.g., an endless intermediate transfer belt 41, a belt cleaner 42, a first bracket 43, and a second bracket 44. The transfer device 40 also includes a plurality of rollers such as four primary transfer rollers 45Y, 45C, 45M, and 45K, a secondary transfer backup roller 46, a drive roller 47, an auxiliary roller 48, and a tension roller 49. The intermediate transfer belt 41 is entrained around the plurality of rollers, and rotated in the counterclockwise direction in FIG. 1 by rotation of the drive roller 47.

The four primary transfer rollers 45Y, 45C, 45M, and 45K sandwiches the intermediate transfer belt 41 together with the photoconductors 3Y, 3C, 3M, and 3K, forming contact areas called primary transfer nips between the intermediate transfer belt 41 and the photoconductors 3Y, 3C, 3M, and 3K, respectively. Each of the four primary transfer rollers 45Y, 45C, 45M, and 45K applies transfer bias having a polarity (e.g., positive polarity) opposite the polarity of toner to an inner circumferential surface of the intermediate transfer belt 41. While the intermediate transfer belt 41 rotates and passes the four primary transfer rollers 45Y, 45C, 45M, and 45K sequentially, a yellow toner image, a cyan toner image, a magenta toner image, and a black toner image are transferred onto the intermediate transfer belt 41 from the photoconductors 3Y, 3C, 3M, and 3K, respectively, such that those toner images are superimposed one another on an outer circumferential surface of the intermediate transfer belt 41. Thus, a four-color toner image is formed on the intermediate transfer belt 41.

The secondary transfer backup roller 46 sandwiches the intermediate transfer belt 41 together with the secondary transfer roller 50 disposed outside a loop formed by the intermediate transfer belt 41, forming a contact area called a secondary transfer nip between the intermediate transfer belt 41 and the secondary transfer roller 50. As described above, the pair of registration rollers 35 feeds the recording medium P toward the secondary transfer nip at a predetermined time so that the four-color toner image is transferred onto the recording medium P from the intermediate transfer belt 41 at the secondary transfer nip. Specifically, the yellow, cyan, magenta, and black toner images constituting the four-color toner image are together transferred onto the recording medium P by a pressure generated at the secondary transfer nip and a secondary transfer electrical field formed between the secondary transfer backup roller 46 and the secondary transfer roller 50 to which secondary transfer bias is applied. The four-color toner image thus transferred forms a full-color toner image together with the white color of the recording medium P.

After the four-color toner image is transferred onto the recording medium P, the belt cleaner 42 removes residual toner from the intermediate transfer belt 41 with a cleaning blade 42a incorporated in the belt cleaner 42. Specifically, the cleaning blade 42a contacts the outer circumferential surface of the intermediate transfer belt 41 and scrapes the residual toner that fails to be transferred onto the recording medium P and therefore remaining on the intermediate transfer belt 41 off the intermediate transfer belt 41.

Above the secondary transfer nip is a fixing device 60. The fixing device 60 includes a pressing roller 61 and a fixing belt unit 62. In some embodiments, the pressing roller 61 may be referred to as pressing and heating roller when it includes a heater such as a halogen lamp. In the present embodiment, the fixing belt unit 62 includes, e.g., a heating roller 63 that includes a heater 63a such as a halogen lamp, an endless fixing belt 64 serving as a fixing member, a tension roller 65, and a drive roller 66. The fixing belt 64 is entrained around the heating roller 63, the tension roller 65, and the drive roller 66, and rotates in the counterclockwise direction in FIG. 1. While the fixing belt 64 is rotating, the heating roller 63 disposed inside a loop formed by the fixing belt 64 heats the fixing belt 64 outwards from an inner circumferential surface of the fixing belt 64.

On the other hand, an outer circumferential surface of the fixing belt 64 contacts the pressing roller 61 that is rotated in a clockwise direction in FIG. 1, while the inner circumferential surface of the fixing belt 64 contacts the heating roller 63. The contact area between the pressing roller 61 and the fixing belt 64 is referred to as a fixing nip.

After passing through the secondary transfer nip and released from the intermediate transfer belt 41, the recording medium P is conveyed to the fixing device 60. The recording medium P bearing the full-color toner image is heated and pressed by the fixing belt 64 and the pressing roller 61, respectively, while passing through the fixing nip upward in FIG. 1. Thus, the full-color toner image is fixed onto the recording medium P. Then, the recording medium P is conveyed to a pair of ejection rollers 67 disposed downstream from the fixing device 60 in a recording medium conveyance direction. The pair of ejection rollers 67 sandwiches the recording medium P between its rollers and ejects the recording medium P onto an ejection tray 68 on top of the image forming apparatus 100. Thus, the plurality of recording media P rest one atop another on the ejection tray 68.

The following describes adjusting density of a solid image according to embodiments of the present invention.

According to embodiments of the present invention, a solid image and a halftone image are outputted with stable image density even under conditions that change developing potential, charging potential, and/or photosensitivity due to, e.g., an elapse of time.

Specifically, first, charging bias and developing bias are set to attain a target density of a solid image (i.e., solid image density), using an exposure intensity that allows an image bearer to maintain residual potential after exposure. Then, the exposure intensity is changed based on the charging bias and the developing bias thus set to detect changes in image density. Based on developed image characteristics ascertainable upon determination of the developing bias, an exposure is determined that generates a predetermined difference between the potential after exposure and the residual potential. Such determination of the exposure, developing bias, and charging bias achieves both the optimum solid image density having a relatively high image density and the optimum halftone density having a relatively low image density.

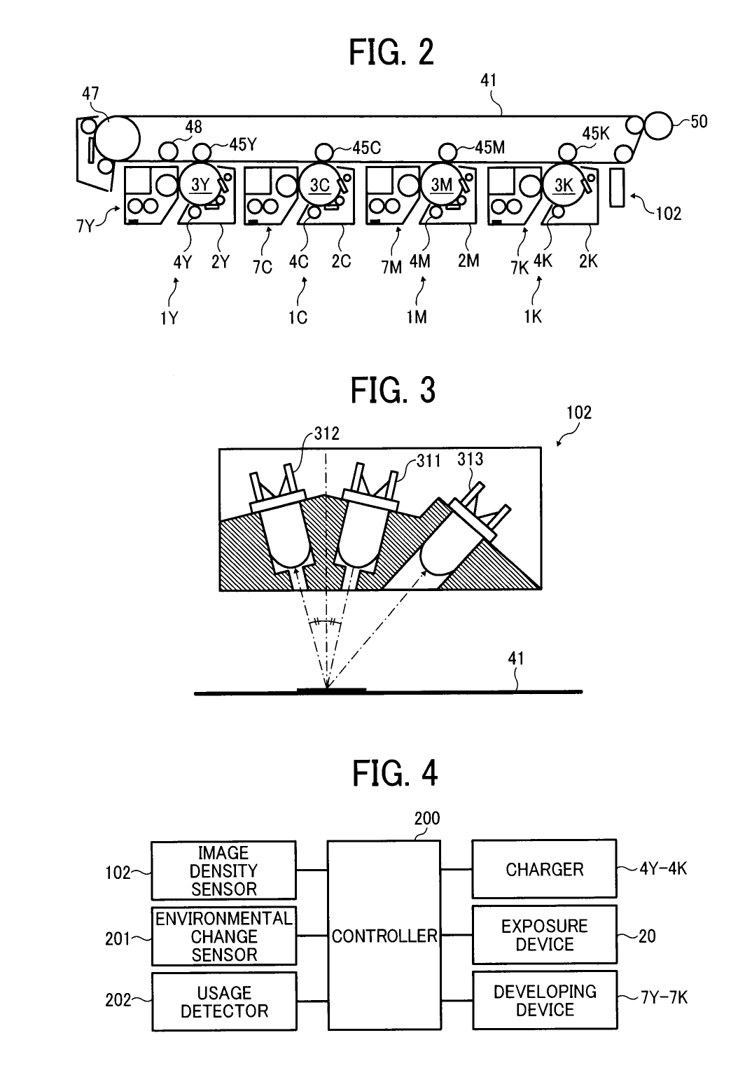

Initially with reference to FIGS. 2 and 3, a description is now given of an optical image density sensor 102 incorporated in the image forming apparatus 100. FIG. 2 is a partial enlarged schematic view of the image forming apparatus 100, illustrating a position of the image density sensor 102. Specifically, the image density sensor 102 is disposed facing the intermediate transfer belt 41. The image density sensor 102 is also operatively connected to a controller 200 as illustrated in FIG. 4, of which a detailed description is deferred.

FIG. 3 is a schematic sectional view of the image density sensor 102. As illustrated in FIG. 3, the density sensor 102 includes, e.g., a light emitting device 311, a first light receiving device 312 that receives regular reflection light, and a second light receiving device 313 that receives diffused reflection light. The light emitting device 311 emits light toward the surface (i.e., outer circumferential surface) of the intermediate transfer belt 41. The first light receiving device 312 receives regular reflection light from the surface of the intermediate transfer belt 41 including a toner patch formed thereon. The density sensor 102 outputs a voltage that corresponds to an amount of regular reflection light thus received. Similarly, the second light receiving device 313 receives diffused reflection light from the surface of the intermediate transfer belt 41 including the toner patch formed thereon. The density sensor 102 outputs a voltage that corresponds to an amount of diffused reflection light thus received.

In the present embodiment, the light emitting device 311 is, e.g., a gallium-arsenide (GaAs) light emitting diode (LED) that emits light having a peak wavelength of about 940 nm. Additionally, each of the first light receiving device 312 and the second light receiving device 313 is a silicon phototransistor that receives light having a peak spectral sensitivity wavelength of about 850 nm. In other words, the image density sensor 102 detects infrared light having a wavelength of about 830 nm or greater without a significant difference of reflection rate between colors. Accordingly, the single image density sensor 102 detects toner patches of all the four colors, that is, yellow, magenta, cyan and black toner patches.

FIG. 4 is a block diagram of the controller 200 operatively connected to some components of the image forming apparatus 100.

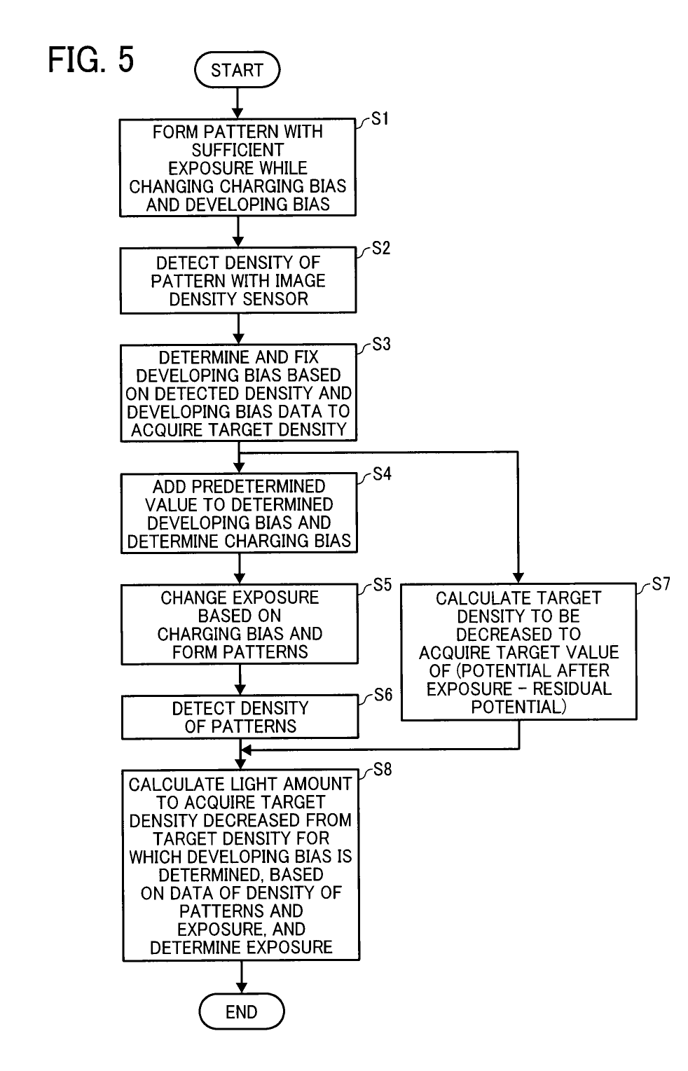

The controller 200 determines an exposure. In the present embodiment, the controller 200 is incorporated in the image forming apparatus 100. Alternatively, in some embodiments, the controller 200 may be disposed outside the image forming apparatus 100. When detecting image density of a control pattern, the image density sensor 102 outputs the detected image density to the controller 200, following a process illustrated in FIG. 5 according to a first embodiment of the present embodiment. In the present embodiment, the image forming apparatus 100 includes an environmental change sensor 201, which is a temperature and humidity sensor. The image forming apparatus 100 also includes a usage detector 202, which is a clock that counts image formation operating time of the photoconductors 3. The charging potential and potential after exposure of the photoconductors 3 serving as image bearers change due to environmental changes and usage of the photoconductors 3. Hence, in the present embodiment, the environmental changes are ascertained by the environmental change sensor 201 and the usage of the photoconductors 3 is ascertained by the image formation operating time of the photoconductors 3 for the control described later. The environmental change sensor 201 and the usage detector 202 output their respective readings to the controller 200. The controller 200 processes the readings received from the image density sensor 102, the environmental change sensor 201, and the usage detector 202 to determine charging bias, an exposure, and developing bias, which are image formation conditions of the chargers 4, the exposure device 20, and the developing devices 7, respectively. Additionally, the controller 200 controls charging bias, exposure, and developing bias to form the control pattern.

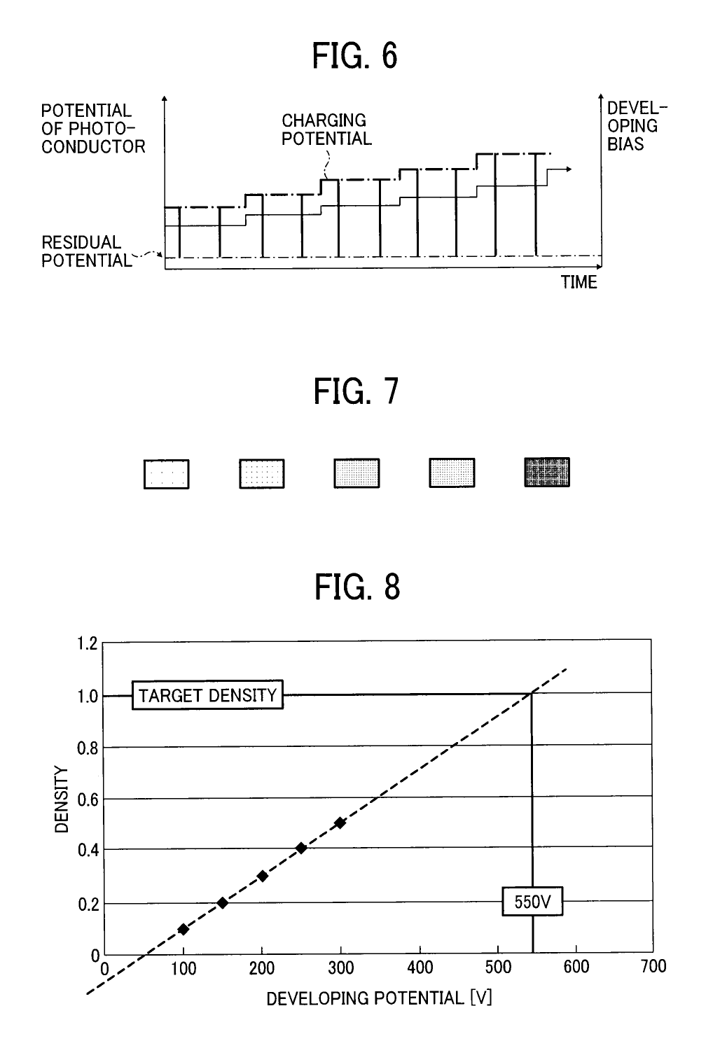

Referring now to FIG. 5 together with FIG. 6 through FIG. 12, a description is given of the process of determining the image formation conditions executed by the controller 200. FIG. 5 is a flowchart of the process of determining the image formation conditions according to the first embodiment.

In step S1, the controller 200 charges the photoconductors 3 at a predetermined time with the chargers 4 such that the charging potential increases in steps as illustrated in FIG. 6. Then, the controller 200 forms a latent solid image pattern on each of the photoconductors 3Y, 3C, 3M, and 3K with the exposure device 20, with an exposure sufficient to maintain residual potential of the photoconductors 3. In other words, the photoconductors 3 maintain saturation potential that does not decrease further after exposure. Then, the controller 200 develops the latent solid image patterns into visible solid image patterns (i.e., toner patterns) with the developing devices 7, by increasing the developing bias in steps as illustrated in FIG. 6. As a result, as illustrated in FIG. 7, a toner pattern for adjusting developing bias is formed on each of the photoconductors 3Y, 3C, 3M, and 3K. The toner patterns for adjusting developing bias are transferred from the photoconductors 3Y, 3C, 3M, and 3K onto the intermediate transfer belt 41 at the primary transfer nips. In step S2, the image density sensor 102 detects density of the toner patterns thus transferred. From residual potential acquired by, e.g., experiments in advance and stored in the controller 200 and the developing bias applied upon development of the latent image patterns, developing potential for each of the toner patterns is calculated. As a result, a relation between developing potential and density of the solid image pattern is acquired as illustrated in the graph of FIG. 8. In step S3, based on the graph, developing potential is determined by, e.g., polynomial equation approximation to acquire a target density for determining developing bias. In short, developing bias is determined. In the present embodiment, the target density for determining developing bias is higher than that of an actual output image, taking into account determination of an exposure described later.

In step S4, the controller 200 determines charging bias. The charging bias is set to acquire predetermined background potential, which is a difference between the developing bias and charging potential of a background of a photoconductor. Usually, a predetermined value is added to a direct-current component of the charging bias to acquire background potential ranging from about 100 V to about 300 V.

After determining the charging bias, the controller 200 determines an exposure, a detailed description of which follows.

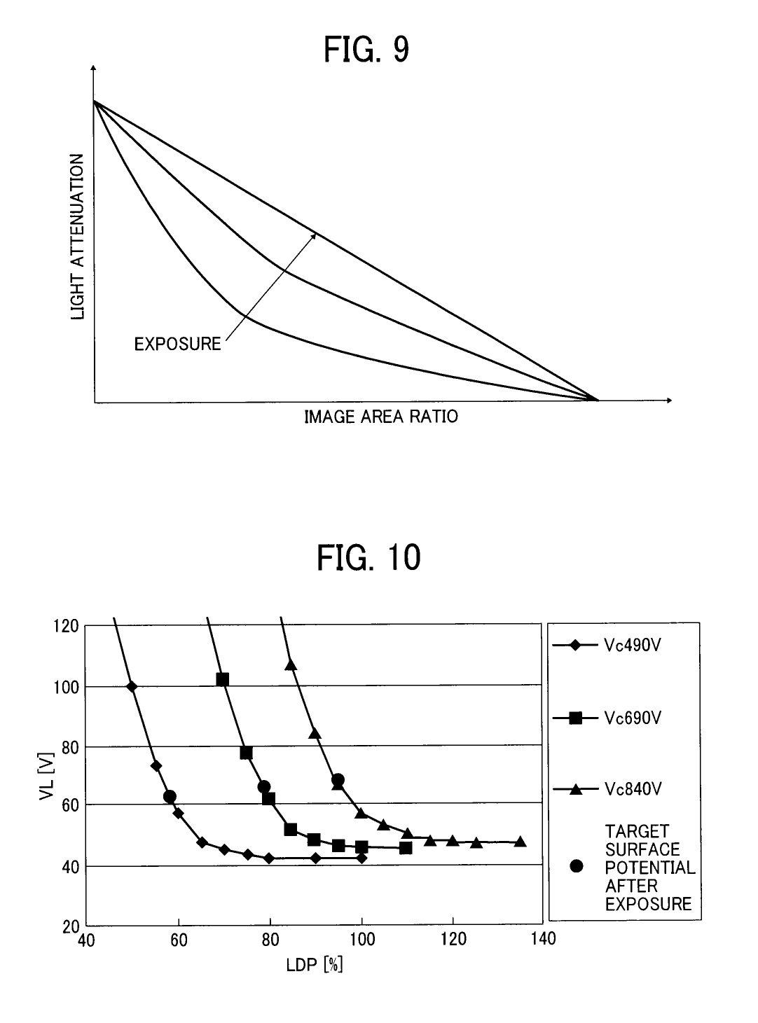

According to embodiments of the present invention, the exposure is a maximum exposure with which digital gamma (γ) is as close to a straight line as is within the capability of the image forming apparatus 100, as characteristics shown in a graph of a relation between image area ratio and light attenuation. FIG. 9 illustrates such a graph, in which the horizontal axis indicates the image area ratio acquired by a writing signal while the vertical axis indicates the light attenuation acquired by (potential after exposure−residual potential)/charging potential. In FIG. 9, the line indicated by an arrow shows a digital γ when an exposure is decreased. The digital γ gets closer to a straight line as the exposure is decreased. When the digital γ is shown as a straight line and the exposure is at its maximum, gradation characteristics are shown as a substantially straight line, thereby providing high image quality.

FIG. 10 illustrates a case in which the exposure is at its maximum, with which the digital γ is shown as a straight line. Specifically, FIG. 10 illustrates results of measurement of after-exposure potential VL by changing charging potential and exposure amount LDP. In FIG. 10, the horizontal axis indicates the exposure amount LDP (%) while the vertical axis indicates the after-exposure potential VL (V). The exposure amount LDP is light energy that a photoconductor receives per unit of time, and is indicated by percentage with respect to a certain value fixed at 100%. Target surface potential after exposure is shown as potential after exposure when the digital γ is shown as a substantially straight line with certain residual potential. FIG. 10 illustrates substantially the same target potential after exposure.

It depends on the image forming apparatus systems employed how much the digital γ gets closer to a straight line. In the image forming apparatus 100, the digital γ is close to a straight line with a correlation coefficient R² not less than 0.97, preferably, not less than 0.98 when the light attenuation data is primarily approximated with respect to the image area ratio. The maximum exposure to acquire the correlation coefficient R² is set as a target exposure. Similarly, a value of (potential after exposure−residual potential) obtained with the target exposure is set as a target value. It is to be noted that, if fine details are not obtained due to system characteristics when using a light amount having a correlation coefficient not less than 0.97, a weakest light amount is used that does not cause such an adverse effect.

Once the system of image forming apparatus is determined, an ideal value of (potential after exposure−residual potential) is determined. Based on the data acquired upon determination of the developing bias, an exposure is determined to obtain the target value of (potential after exposure−residual potential).

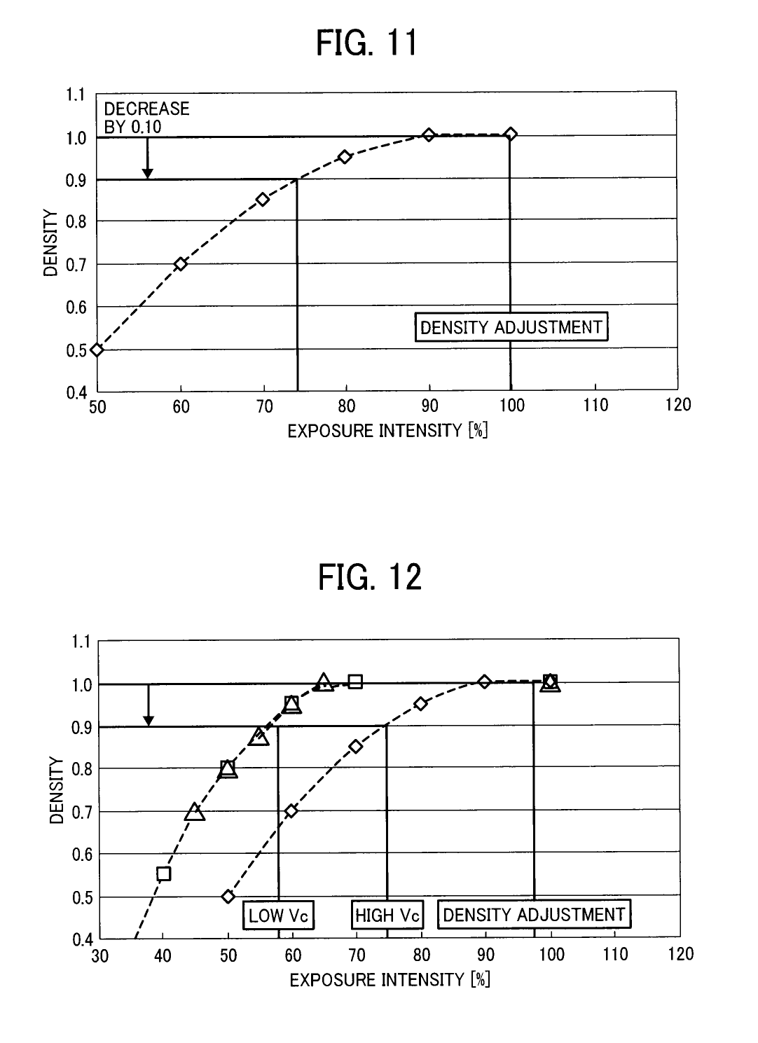

For example, if the data acquired upon determination of the developing bias is as illustrated in FIG. 8, the density of the solid image pattern increases by 1.0 when the developing potential increases by 500 V. In other words, the density changes by 0.1 when the developing potential changes by 50 V. Provided that a target value of (potential after exposure−residual potential) is 50 V, the target value is potential of a solid image pattern having a density decreased by 0.1 from the density of the solid image pattern corresponding to residual potential. Hence, a solid image pattern is formed on a photoconductor having residual potential and another pattern is formed by decreasing the exposure, losing the residual potential. If the results of measurement of density of the patterns are as illustrated in FIG. 11, an exposure that decreases the density by 0.1 is acquired. As a result, a target exposure condition is set to maintain fine details.

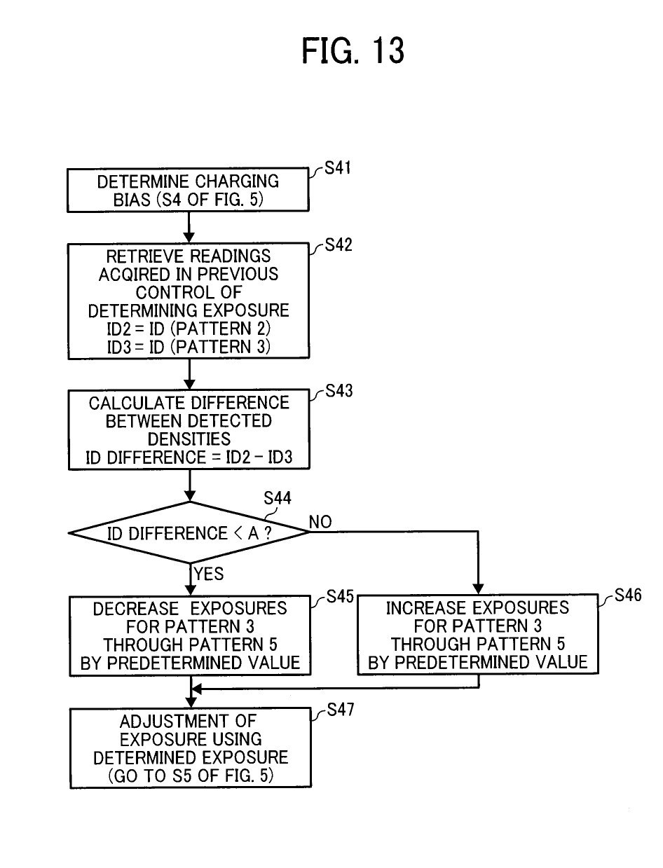

Referring back to FIG. 5, in step S5, the controller 200 forms patterns by changing the exposure based on the charging bias determined in the previous step. Alternatively, the controller 200 may form a pattern by decreasing the exposure by a certain amount, without reference to the charging bias. However, as illustrated in FIG. 12, the exposure to be determined significantly differs between high charging potential (high Vc) and low charging potential (low Vc). Therefore, in the present embodiment, the exposure is changed based on the charging bias to reduce the number of patterns.

Table 1 below shows some patterns formed by changing exposure with respect to charging bias. The patterns have different exposures as references except for Pattern 1, which has the same exposure regardless of the charging bias to acquire residual potential. On the other hand, for example, Pattern 2 shows the exposure decreasing relative to charging bias. The difference in exposure between adjacent patterns decreases in proportion to charging bias. These references are determined in advance by preparing a reference photoconductor and obtaining a correlation between charging bias and potential after exposure by, e.g., experiments. In Table 1, the reference difference between adjacent patterns from Pattern 2 to Pattern 6 at a direct-current (DC) component of a 420 V charging bias is half the reference difference between adjacent patterns from Pattern 2 to Pattern 6 at a DC component of a 840 V charging bias in proportion to charging bias. By changing exposure with respect to charging bias, a pattern is formed with an appropriate reference with respect to charging potential as illustrated in FIG. 12.

TABLE 1

| DC COMPONENT OF | PATTERN | | | | | |
|---|---|---|---|---|---|---|
| CHARGING BIAS | 1 | 2 | 3 | 4 | 5 | 6 |
| 900 V | 100 | • | • | • | • | • |
| 870 V | 100 | • | • | • | • | • |
| 840 V | 100 | 90 | 80 | 70 | 60 | 50 |
| 810 V | 100 | • | • | • | • | • |
| • | • | • | • | • | • | • |
| • | • | • | • | • | • | • |
| 420 V | 100 | 65 | 60 | 55 | 50 | 45 |
| • | • | • | • | • | • | • |
| • | • | • | • | • | • | • |

A look-up table such as Table 1 is stored in the controller 200. After determination of the charging bias, patterns for determining an exposure are formed with reference to the look-up table in step S5. In step S6, the density of the patterns is detected to create data as illustrated in FIG. 11 or FIG. 12.

In step S7, a density to be decreased is calculated to acquire a target value of (potential after exposure−residual potential) from the developed image characteristics illustrated in FIG. 8. In step S8, an exposure is determined based on the data of FIG. 11 or FIG. 12.

Thus, the developing bias, charging bias, and exposure are determined by forming a solid image pattern. In other words, the process is completed ascertaining the density of the solid image density after the process. Therefore, the solid image density does not deviate from the target image density. As described above, the target density for determining the developing bias is set higher than the target output image density taking into account the density to be decreased for determining the exposure. As a result, the density of an output solid image is stably set as a target density. In addition, since determination of the exposure is based on the digital γ, fine details have a stable density.

Now, a description is given of determining an exposure according to a second embodiment of the present invention.

In the second embodiment, exposure intensity is used that changes a certain level of image density. According to the first embodiment, the density to be decreased is calculated to acquire a target value of (potential after exposure−residual potential) and to determine the exposure, based on the characteristics illustrated in FIG. 8. However, the density to be decreased may remain substantially the same depending on the imaging system. In such a system, the exposure is determined based on the density to be decreased, without calculating it from the developed image characteristics. According to the second embodiment, the exposure is set to acquire a certain density to be decreased. Specifically, for example, calculation of the density to be decreased (S7 of FIG. 5) is omitted, and the target density to be decreased is fixed at 0.1, thereby obviating the need for calculation.

Referring now to FIG. 13, a description is given of determining an exposure according to a third embodiment of the present invention.

FIG. 13 is a flowchart of a process of determining an exposure according to the third embodiment. In the third embodiment, the reference exposure is adjusted based on the data obtained in step S6 of previous control of determining an exposure. The overall process is substantially the same as the process of FIG. 5, except for the steps after step S4 of FIG. 5. In step S41 (corresponding to S4 of FIG. 5), charging bias is determined. In step S42, the density readings acquired in the previous control of determining an exposure is retrieved from a storage. For example, a detected density ID2 of Pattern 2 and a detected density ID3 of Pattern 3 are retrieved from the storage. In step S43, the difference (ID difference) between ID2 and ID3 is calculated. In step S44, it is determined whether the difference is below a predetermined value A. If so (YES in S44), the exposures for Pattern 3 through Pattern 5 are decreased by a predetermined value X in step S45; if not (NO in S44), the exposures for Pattern 3 through Pattern 5 are increased by the predetermined value X in step S46. Then, the process proceeds to step S47, that is, S5 of FIG. 5. Following such a process acquires an appropriate difference between exposures upon formation of patterns.

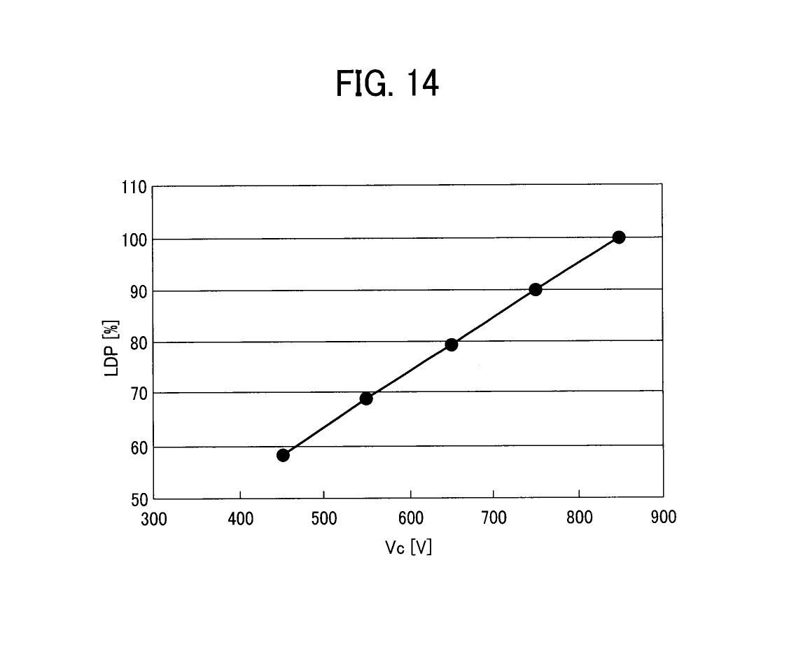

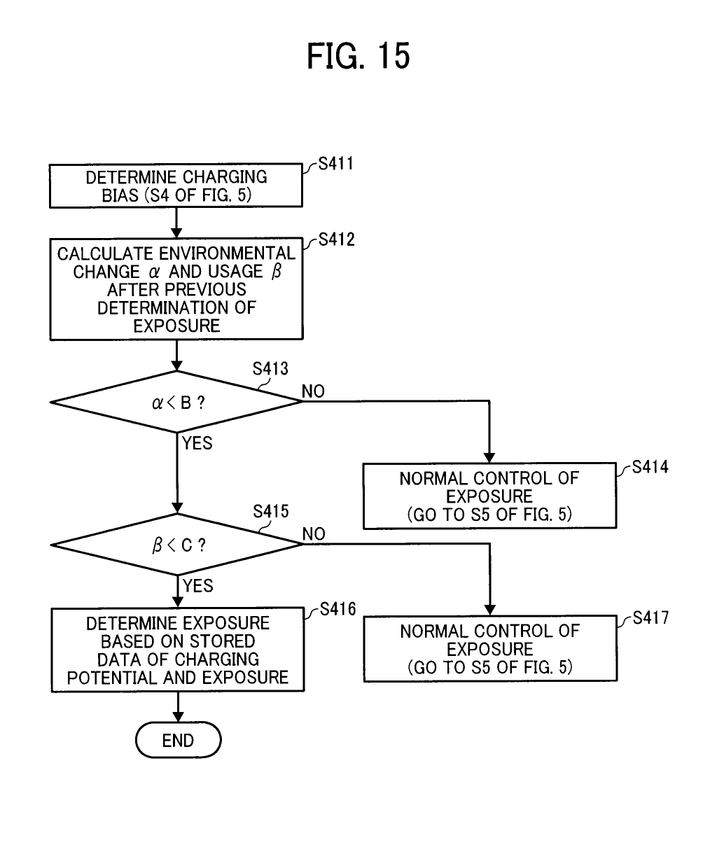

Referring now to FIGS. 14 and 15, a description is given of determining an exposure according to a fourth embodiment of the present invention. In the fourth embodiment, adjustment of exposure intensity is simplified under the conditions described above, based on a relation between exposure intensity and specific charging potential determined, in addition to the above-described embodiments. FIG. 14 illustrates a relation between charging potential and exposure. Such a relation is obtained by, e.g., experiments using a reference photoconductor. The straight line illustrated in FIG. 14 may be displaced parallelly due to deterioration of the photoconductor and/or environmental changes while maintaining the same gradient. In this system, according to the present embodiment, adjustment of exposure intensity is omitted within a range of environmental changes and usages that do not significantly change the relation of FIG. 14, because reducing the frequency of adjusting the exposure intensity may decrease cost per page (CPP) and shorten a standby time.

FIG. 15 is a flowchart of a process of determining an exposure according to the fourth embodiment. The overall process is substantially the same as the process of FIG. 5, except for the steps after step S4 of FIG. 5. In step S411 (corresponding to S4 of FIG. 5), charging bias is determined. In step S412, an environmental change α and a usage β after a previous control of determining an exposure are calculated. More specifically, the temperature and humidity detected after current determination of the charging bias is compared with the temperature and humidity detected and stored in the previous control of determining an exposure. The environmental change α is, e.g., an absolute humidity difference. The usage β is, e.g., a running time of a photoconductor from the previous control of determining an exposure. The environmental change α and the usage β are detected by the environmental change sensor 201 and the usage detector 202, respectively, both of which are illustrated in FIG. 4. In step S413, it is determined whether the environmental change α is below a predetermined change level B. Similarly, in step S415, it is determined whether the usage β is below a predetermined change level C. If it is determined that the environmental change α is below the predetermined change level B (YES in S413) and that the usage β is below the predetermined change level C (YES in step S415), then, in step S416, the exposure is determined based on the change level from the previous charging bias (i.e., charging potential) and the gradient of the linear graph of FIG. 14 stored in the image forming apparatus 100. On the other hand, if it is determined that the environmental change α is not below the predetermined change level B (NO in S413), then, the process proceeds to step S414 corresponding to step S5 of FIG. 5 and follows the subsequent steps of FIG. 5 to determine the exposure. Similarly, if it is determined that the usage β is not below the predetermined change level C (NO in step S415), then, the process proceeds to step S417 corresponding to step S5 of FIG. 5 and follows the subsequent steps of FIG. 5 to determine the exposure.

In some embodiments, step 415 may be omitted in image forming apparatuses that have little usage changes. For example, if it is determined that the environmental change α is below the predetermined change level B (YES in S413), then, the process proceeds to step S416, omitting steps S415 and S417. Alternatively, in some embodiments, step S413 may be omitted in image forming apparatuses that have little environmental changes. In this case, the process may proceed from step S412 to step S415, omitting steps S413 and S414.

As described above, according to embodiments of the present invention, a plurality of patterns are formed by decreasing an exposure from an exposure that saturates potential of a photoconductor after exposure. The density of the plurality of patterns is detected to determine an exposure to output an image, with which the photoconductor obtains desired potential after exposure, based on data of image density and developing development field. As a result, both a solid image having a relatively high image density and a halftone image having a relatively low image density are outputted with their target image densities.

Numerous additional modifications and variations are possible in light of the above teachings. It is therefore to be understood that within the scope of the appended claims, the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of the present invention and appended claims.

Further, any of the above-described devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

What is claimed is:

1. An image forming apparatus comprising:
an image bearer;
a charger to charge the image bearer;
an exposure device to expose the image bearer charged by the charger to form an electrostatic latent image on the image bearer;
a developing device to develop the electrostatic latent image with toner into a toner image;
an image density sensor to detect image density of the toner image; and
a controller to determine an exposure, configured to:
charge the image bearer with the charger;
expose the image bearer with the exposure device with a first exposure that saturates potential of the image bearer after exposure to form a latent image pattern on the image bearer;
develop the latent image pattern into a toner pattern with the developing device while changing a developing electrical field;
detect a first image density of the toner pattern with the image density sensor;
determine developing bias and charging bias based on the first image density and data of the developing electrical field;
form a plurality of patterns with the first exposure and with a second exposure smaller than the first exposure based on the charging bias and the developing bias;
detect a second image density of the plurality of patterns with the image density sensor; and
determine an exposure to output an image based on the second image density, the first exposure, and the second exposure.

2. The image forming apparatus according to claim 1, wherein the exposure to output an image is a maximum exposure that allows digital gamma characteristics to be closest to a straight line in the image forming apparatus.

3. The image forming apparatus according to claim 1, wherein the controller sets the exposure to output an image to acquire a predetermined density difference between the pattern formed with the first exposure and a pattern formed with the exposure to output an image.

4. The image forming apparatus according to claim 3, wherein the controller sets a target image density including the predetermined difference upon determination of the developing bias and the charging bias.

5. The image forming apparatus according to claim 1, wherein the second exposure varies with the charging bias.

6. The image forming apparatus according to claim 5,
wherein the controller further forms a pattern with a third exposure smaller than the first exposure based on the charging bias and the developing bias, and
wherein a difference between the second exposure and the third exposure changes in proportion to the charging bias.

7. The image forming apparatus according to claim 1, wherein the controller adjusts the second exposure based on data acquired during a previous control.

8. The image forming apparatus according to claim 1, further comprising an environmental change sensor to detect an environmental change,
wherein the controller determines and adjusts an exposure based on the charging bias if the environmental change detected by the environmental change sensor is below a predetermined level.

9. The image forming apparatus according to claim 1, further comprising a usage detector to detect a usage of the image forming apparatus,
wherein the controller determines and adjusts an exposure based on the charging bias if the usage detected by the usage detector is below a predetermined level.

10. The image forming apparatus according to claim 1, further comprising an environmental change sensor to detect an environmental change and a usage detector to detect a usage of the image forming apparatus,
wherein the controller determines and adjusts an exposure based on the charging bias if the environmental change detected by the environmental change sensor is below a predetermined level and if the usage detected by the usage detector is below a predetermined level.

11. An image forming method comprising:
charging an image bearer;
exposing the image bearer with a first exposure that saturates potential of the image bearer after exposure to form a latent image pattern on the image bearer;
developing the latent image pattern into a toner pattern while changing a developing electrical field;
detecting a first image density of the toner pattern;
determining developing bias and charging bias based on the first image density and data of the developing electrical field;
forming a plurality of patterns with the first exposure and with a second exposure smaller than the first exposure based on the charging bias and the developing bias;
detecting a second image density of the plurality of patterns; and
determining an exposure to output an image, based on the second image density, the first exposure, and the second exposure.
